(19) United States
(12) Patent Application Publication
(10) Pub. No.: US 2011/0102993 A1
(43) Pub. Date: May 5, 2011

(54) CARD READER

(76) Inventor: Yu-Ching PANG, Yonghe City (TW)

(21) Appl. No.: 12/611,632

(22) Filed: Nov. 3, 2009

(51) Int. Cl. G06F 1/16

(52) U.S. Cl. 361/679.4; 439/540.1

(57) ABSTRACT

A card reader includes a housing, an interior of which is defined with plural holding slots accommodating interface units respectively. The interface units are connected respectively with control units which are primarily a single chip. The interface units are storage devices, such as MS, CF, SD, XD, USB, microSD or M2. The housing is further provided with a cover board on which are disposed with perforations at locations corresponding to the interface units. When a user is to replace, update or repair the card reader, he or she can take down the cover board and then perform a respective operation to the interface unit to be replaced, updated or repaired independently, without removing other interface units together. Therefore, time and labor works can be reduced, expandability is high, and an unnecessary cost spent can be saved.

### BACKGROUND OF THE INVENTION

a) Field of the Invention

The present invention relates to a card reader, and more particularly to a card reader which can be repaired, replaced and updated independently.

b) Description of the Prior Art

Referring to FIG. 1, it shows a three-dimensional schematic view of a conventional card reader. The card reader 20 is provided with a housing 21, a panel 22 which is located at an end surface of the housing 21 and is equipped with plural slots 221 (multi-in-one slot), a processing unit 23 which is located in the housing 21 and a connection part 24 which is connected with the processing unit 23 and is extended out of the other end surface of the housing 21. Accordingly, the connection part 24 can be connected externally to a connection port 251 of a computer 25 and a required memory card 26 can be inserted into the slot 221, thereby facilitating the computer 25 to read from and write into the memory card 26.

Although the aforementioned conventional card reader 20 can be connected externally to the computer 25, allowing the computer 25 to read from and write into the memory card 26, as the card reader 20 is connected externally to the computer 25, a user has to connect the connection part 24 to the connection port 251 (normally a USB (Universal Serial Bus) port) in front of or at a rear side of the computer 25 when using the card reader 20, and then remove the connection part 24 when the card reader 20 is not used. Therefore, if the computer 25 is located underneath a desk, then it will cause a trouble to the user when he or she connects or removes the connection part 24. In addition, in order to facilitate inserting the memory card 26, the user will usually put the card reader 20 on the desk to occupy a space on the desktop. Besides, the card reader 20 can only carry out the read-write function of the memory card 26, but is unable to provide an expansion function. Therefore, to solve this issue, a built-in card reader is invented. This built-in card reader includes a computer which is provided with at least a frame, a housing, a front cover board, a rear cover board, a mother board and a power supply, with the front cover board being provided with plural perforations; and an accessing mechanism which is transfixed into one perforation on the front cover board and is provided with at least a control unit connected with the mother board and the power supply, four USB connectors connected with the control unit and correspondingly provided at a same side of the front cover board, and a card reader unit connected with the control unit, being provided with slots and located at the same side of the front cover board. Accordingly, the accessing mechanism can be fixed on the computer that in addition to utilizing the card reader unit to read from and write into the memory card, four USB connectors can be used to connect with external equipment, such that the space will not be occupied and the application can be convenient.

However, when the aforementioned built-in card reader 20 is used, following issues and shortcomings actually exist to be improved.

Although the built-in card reader 20 can be inserted with plural memory cards 26 of various interfaces, if one slot 221 is damaged or malfunctioning, then the entire card reader 20 has to be dismantled, which is very troublesome. Moreover, the damaged slot 221 cannot be simply dismantled for repairing; and in terms of expandability, the connectors cannot be replaced according to various technologies. As the entire card reader 20 needs to be replaced, the cost spent is really unacceptable.

Accordingly, how to solve the aforementioned issues and shortcomings of the prior art is a direction of research and development for improvement by the present inventor and related vendors.

### SUMMARY OF THE INVENTION

The primary object of the present invention is to provide a card reader which is composed of a housing accommodating interface units, with the interface units being storage devices such as MS (Memory Stick), CF (Compact Flash), SD (Secure Digital), XD (Extreme Digital), USB, microSD (micro Secure Digital) or M2 (Memory Stick Micro). These interface units operate independently and are connected to a control unit respectively. The interface units can be dismantled independently according to a user's preferences, to carry out replacement, updating or repairing, such that when the user is to repair or update, he or she only needs to dismantle the interface unit to be repaired or updated. By the aforementioned technologies, the issues existing in the conventional built-in card reader that although the built-in card reader can be inserted with plural memory cards of various interfaces, if one slot is damaged or malfunctioning, then the entire card reader has to be dismantled, which is very troublesome; and moreover, the damaged slot cannot be simply dismantled for repairing and in terms of expandability, the connectors cannot be replaced according to various technologies and as the entire card reader needs to be replaced, the cost spent is really unacceptable; can be solved. Therefore, by the plural interface units which are provided independently, the user can dismantle the individual interface unit to be replaced, updated or repaired, not like that when the conventional built-in card reader is to be replaced, updated or repaired, the entire card reader needs to be dismantled. Accordingly, the card reader of the present invention is provided with extremely high expandability to reduce time and labor works and save an unnecessary cost spent. In addition, as the independent slots are used, the user can be more clearly and explicitly aware of positions of all kinds of memory slots and will not insert by a mistake to damage the card reader or the memory card.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a three-dimensional schematic view of a conventional card reader.

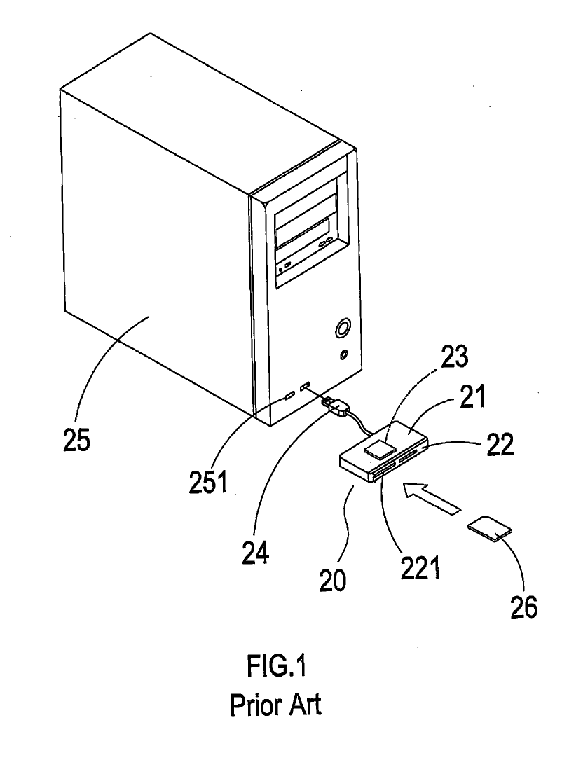

FIG. 2 shows a three-dimensional schematic view of a preferred embodiment of the present invention.

FIG. 3 shows a block diagram of the preferred embodiment of the present invention.

FIG. 4 shows a schematic view of an implementation of the preferred embodiment of the present invention.

### DETAILED DESCRIPTION OF THE PREFERRED EMBODIMENTS

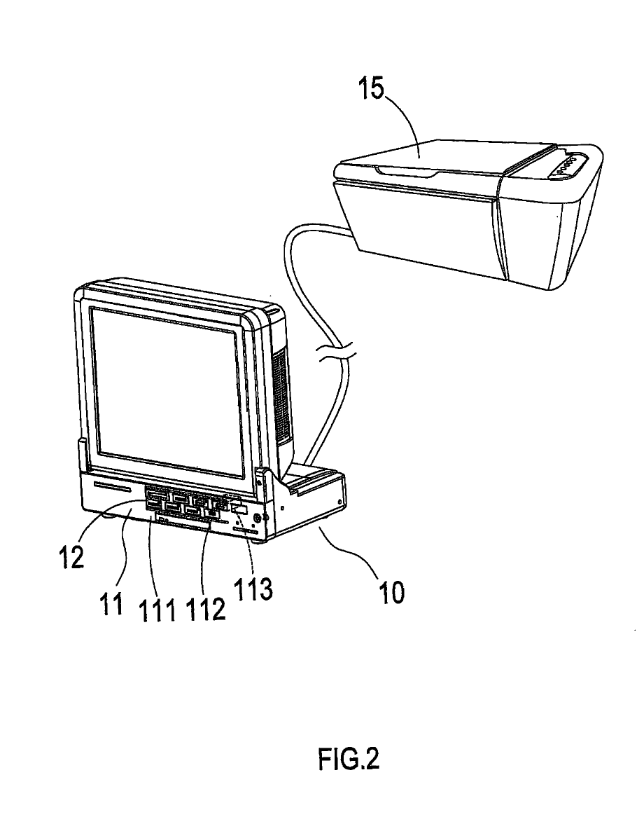

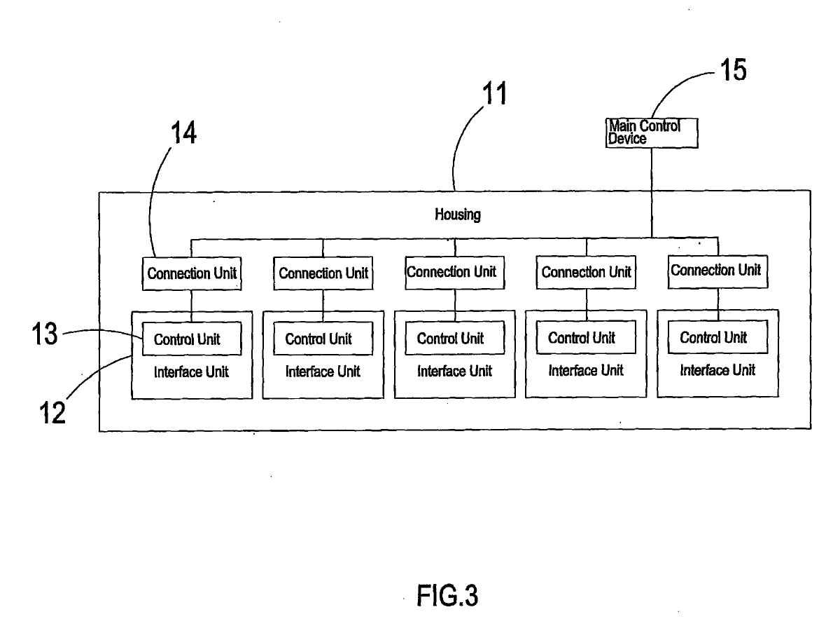

Referring to FIG. 2 and FIG. 3, it shows a three-dimensional schematic view and a block diagram, of a preferred embodiment of the present invention. As shown in the drawing, a card reader 10 of the present invention comprises:

a housing 11, which is further provided with a cover board 111 being disposed with perforations 112 at locations corresponding to interface units 12 described below, and an interior of which is further defined with holding slots 113;

the plural built-in interface units 12 which are accommodated in the holding slots 113 of the housing 11 independently, and are connected respectively with a control unit 13 that can be a single chip, with the interface units 12 being storage devices, such as MS, CF, SD, XD, USB, microSD or M2; and

plural connection units 14 which are assembled correspondingly with the aforementioned control units 13 and can be further connected with a main control device 15 that can be a photo developing device, a printer, a computer or any device able to read from a memory card.

Accordingly, the interface units 12 can be extracted, replaced, repaired and operating independently.

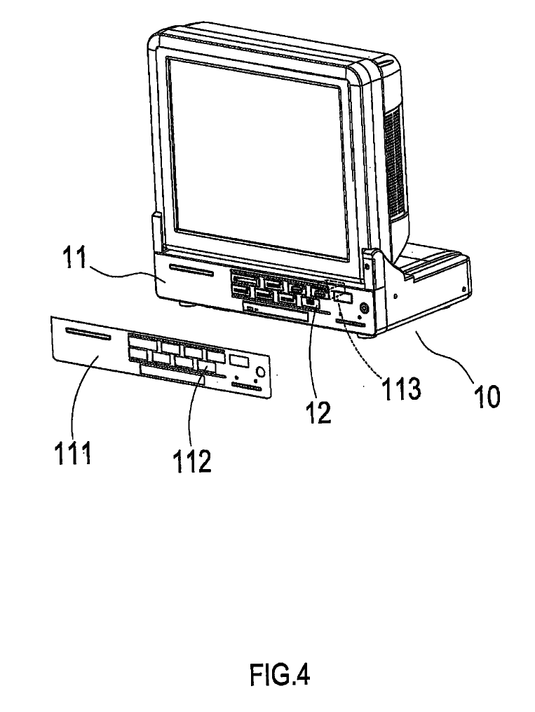

Referring to FIG. 3 and FIG. 4, it shows a block diagram and a schematic view of an implementation, of the preferred embodiment of the present invention. As shown in the drawings, the card reader 10 includes the housing 11. The holding slots 113 in the housing 11 accommodate the plural interface units 12 which are connected respectively with the control units 13, and the control units 13 are assembled correspondingly with the connection units 14. Moreover, the housing 11 is further provided with the cover board 111 on which are disposed with the perforations 112 corresponding to the interface units 12. Therefore, when the user is to replace, update or repair the interface units 12, he or she takes down the cover board 111 first to dismantle the interface unit 12 to be replaced, updated or repaired, independently. At a same time when the interface unit 12 is pulled out, the interface unit 12 and the control unit 13 are separated with the connection unit 14. Next, the dismantled interface unit 12 is replaced, updated or repaired. On the other hand, when the interface unit 12 is to be assembled, the interface unit 12 is directly put into the holding slot 113 and the control unit 13 is assembled with the connection unit 14, so as to accomplish the independent dismantlement and assembling.

Referring to all the drawings, the present invention is actually provided with following advantages when compared with the prior art.

By the plural interface units 12 that are provided independently, the user can dismantle the interface unit 12 to be replaced, updated or repaired respectively, not like that when the conventional built-in card reader 20 is to be replaced, updated or repaired, the entire card reader has to be dismantled. In addition, the card reader 10 of the present invention can be dismantled for expansion and addition according to the user's preferences, allowing the card reader 10 to be provided with extremely high expandability to reduce time and labor works, and save the unnecessary cost spent. Furthermore, as the independent slots are used, the user can be more clearly and explicitly aware of the positions of all kinds of memory slots and will not insert by a mistake to damage the card reader or the memory card.

It is of course to be understood that the embodiments described herein is merely illustrative of the principles of the invention and that a wide variety of modifications thereto may be effected by persons skilled in the art without departing from the spirit and scope of the invention as set forth in the following claims.

1-6. (canceled)

7. A card reader comprising:
a housing having a plurality of slots;
a plurality of interface units each fitted in a respective one of said slots of said housing;
a cover board engaged with said housing, said cover board having a plurality of perforations at locations corresponding to said interface units;
a plurality of control units each connected with a respective one of said interface units;
a plurality of connection units each assembled with a respective one of said control units; and
a main control device connected with said connection units.

8. The card reader as claimed in claim 7, wherein said interface units are storage devices.

9. The card reader as claimed in claim 7, wherein said control units are a single chip.

10. The card reader as claimed in claim 7, wherein said main control device is a printer, a photo developing device or a computer.
